(19) United States
(12) Patent Application Publication
(10) Pub. No.: US 2004/0167744 A1
(43) Pub. Date: Aug. 26, 2004

(54) Measuring method for pattern-dots of light guide plate

(76) Inventor: Jyhchain Lin, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/788,749

(22) Filed: Feb. 26, 2004

(30) Foreign Application Priority Data
Feb. 26, 2003 (TW) 92103973

(51) Int. Cl. G01B 5/26

(52) U.S. Cl. 702/156

(57) ABSTRACT

A method for measuring area density of pattern-dots (14) for a light guide plate (10) includes the steps of: defining a coordinate system according to the dots; selecting a unit area (142) in the coordinate system; accounting area of the dots in the unit area; and calculating area density of the dots. Quantity of the dots in each unit area is invariableness, and area of each dot in the unit area is uniform. It is convenient to measuring area density of pattern-dots for a light guide plate by using this method.

### BACKGROUND OF THE INVENTION

1. Field of the Invention

The present invention is related to a method for measuring area density of pattern-dots for a light guide plate.

2. Description of Prior Art

A typical liquid crystal display device comprises an LCD panel, and a backlight system mounted under the LCD panel for supplying light beams thereto. The backlight system mainly comprises a light source and an light guide plate, the light guide plate is normally made of a transparent acrylic plastic plate and is used for guiding the light beams emitted by the light source to uniformly illuminate the liquid crystal display panel.

A light guide plate mainly has a light emitting surface, and an opposite bottom surface. In order to diffuse the light beams and emit them uniformly from the light emitting surface, a pattern of light diffusion dots are formed on the bottom surface of the light guide plate.

Customarily, the pattern-dots are distributed according to row lines and column lines which are prearranged on a bottom surface of a light guide plate. The row lines are perpendicular to the column lines, and the pattern-dots are disposed at points of intersection of the row lines and column lines. It is well known that, area density of the pattern-dots is an important characteristic, which affect the uniformity and brightness of light beams emitted from a light emitting surface. Consequently, it is signified to calculate the area density of the pattern-dots in order to evaluate the optical characteristics of the output light of the light guide plate.

Conventionally, a method for measuring area density of the pattern-dots includes the steps of: defining several unit areas; accounting area of each unit areas; accounting area of the pattern-dots in each unit area; calculating area density of the light guide plate.

However, for the conventional method, it needs to calculate the amount of the pattern-dots disposed in every certain unit area, and the area of each pattern-dot distributed in every certain unit areas. This calculation is complicated, and the method is inconvenient.

Therefore, it is desired to provide a new method which overcomes the above-described disadvantage of the conventional method.

### SUMMARY OF THE INVENTION

It is an object of the present invention to provide a method for conveniently measuring area density of pattern-dots for a light guide plate.

In order to achieve the object set out above, a method for measuring area density of pattern-dots for a light guide plate comprises the steps of: defining a coordinate system according to the dots; selecting a unit area in the coordinate system; accounting area of the dots in the unit area; calculating area density of the dots. Quantity of the dots in each unit area is invariableness, and area of each dot in the unit area is equal.

Other objects, advantages and novel features of the present invention will be apparent from the following detailed description of preferred embodiments thereof with reference to the attached drawings.

### BRIEF DESCRIPTION OF THE DRAWINGS

FIG. 1 is a flow chart of a method for measuring area density of pattern-dots in accordance with the present invention.

FIG. 2 is a perspective view of a light guide plate used in the measuring method shown in FIG. 1.

FIG. 3 is a schematic view of the measuring method in FIG. 1.

FIG. 4 is a schematic view of a method for measuring area density in accordance with a second embodiment of the present invention.

### DETAILED DESCRIPTION OF THE PRESENT INVENTION

Referring to FIG. 1, a flow chart of a method for measuring area density of pattern-dots on a light guide plate. The method includes the steps of: defining a coordinates system according to dots; selecting a unit area in the coordinates system; accounting area of the dots in the unit area; calculating area density of the dots.

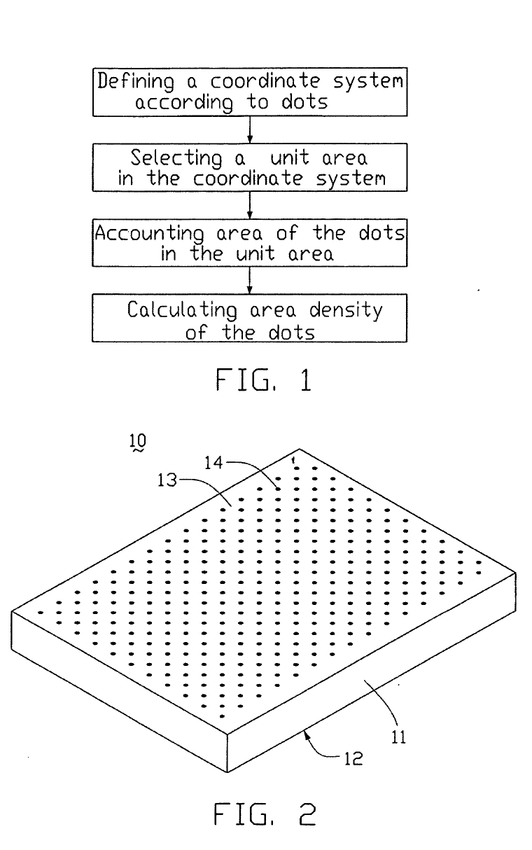

Referring to FIG. 2, a perspective view of a light guide plate used in the measuring method. The light guide plate 10 comprises a light incident surface 11, a light exit surface 12 adjoining the light incident surface 11, and a bottom surface 13 opposite to the light exit surface 12. The light guide plate 10 can be made of transparent acrylic resin. The light guide plate 10 defines a plurality of diffusion dots 14 on the bottom surface 13. The dots 14 are arranged in a uniform pattern, and the shape of the dots 14 is circular.

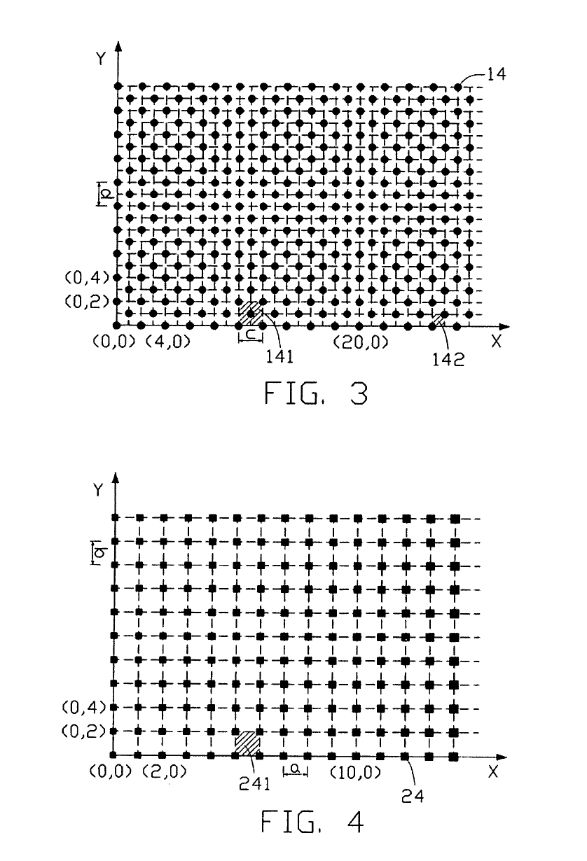

Referring to FIG. 3, a schematic view of the method according to the present invention is shown. The dots 14 are arranged in rows and columns at respectively same intervals on the bottom surface 13 of the light guide plate 10, in which the dots 14 have a uniform size. In a row, a distance between two nearby dots 14 is c, i.e., column spacing is c. In a column, a distance between two nearby dots 14 is d, i.e., row pitch is d. The dots 14 are also disposed on points of intersection of half row pitch and half column spacing. A method for measuring area density of the dots 14 comprises the steps of:

(1) defining a coordinates system (x, y) according to the dots 14 of the light guide plate 10;

(2) measuring a semi diameter of the dots 14;

(3) selecting a unit area 142 in the coordinates system (x, y);

(4) accounting area of the dots 14 in the unit area 142;

(5) calculating area density of the dots 14.

In step (1), first, defining a dot 14 in a corner of the light guide plate 10 as an origin of coordinates. Second, defining a X,Y coordinates system according to a row and a column of the dots pattern, in which, half of the distance c is taken as a unit of X-coordinate, and half of distance d is taken as a unit of Y-coordinate. And defining a coordinate of the dot 14 as (n, m)

In step (2), measuring a semi diameter of a dot 14 as r_{(n, m)}.

In step (3), taking a quarter of a single pixel 141 as a certain unit area 142. Area of each unit area 142 can be expressed by the following equation:

S_{(n, m)}=cd/4

wherein, (n, m) is the coordinate of the dot 14 in the corner of the unit are 142.

In step (4), area of the dots 14 in the unit area 142 can be calculated conveniently by the following equation:

A_{(n,m)}=0.25π[r² _{(n,m)}+r²_{(n,m)}+r²_{(n,m+1)}+r²_{(n+1,m+1)]}

Eventually, in step (5), area density of the dots 14 of the pattern can be expressed by the following equation:

σ=π[r²_{(n,m)}+r²_{(n+1,m)}+r²_{(n,m+1)}+r²_{(n+1,m+1})]/cd

Quantity of the dots 14 in each unit area 142 is equal, a quarter of area of each dots 14 are distributed in a certain unit area 142, respectively. Therefore, it doesn't require calculate the amount of the pattern-dots 14 disposed in a certain unit area 142, and the area of each dot 14 distributed in the certain unit area 142. Conveniently measuring area density of the pattern-dots of a light guide plate is realized by using the method mention above.

Referring to FIG. 4, a schematic view of a method for measuring area density in accordance with a second embodiment of the present invention. The shape of the dots 24 is foursquare. The dots 24 are arranged in rows and columns at respectively same intervals, in which the dots 24 have a uniform size. In a row, a distance between two nearby dots 24 is a. In a column, a distance between two nearby dots 24 is b. A method for measuring area density of the pattern-dots 24 comprises the steps of:

(1) selecting a dot 24 in the corner as a origin of coordinates, and defining a coordinates system according to a row and a column of dots pattern, in which the distance c is take as a unit of X-coordinate, and the distance d is taken as a unit of Y-coordinate. And defining a coordinate of a dot 14 as (n, m);

(2) defining length of edge of a dot 24 as 1_{(n, m)};

selecting a single pixel as a unit area 241, area of the unit area 241 can be expressed as:

S_{(n,m)}=ab

wherein, (n, m) is a coordinate of the dot 24 in the corner of the unit area 241;

(4) accounting area of the dots 24 in the unit area, it can be expressed as:

A_{(n,m)}=0.25[1²_{(n,m)}+1²_{(n+1,m)}+1²_{(n,m+1)}+1²_{(n+1,m+1)]}

calculating area density of the dots 24, it can be expressed by the following equation:

σ=0.25 [1²_{(n,m)}+1²_{(n+1,m)}+1²_{(n,m+1)}+1²_{(n+1,m+1)}]/ab

Of course, the shape of the dots 24 is not limit to that stated above, the dots can also shaped as rectangular, elliptic or the like. Advantages of the present invention over the prior art is that this method measuring the area density of the pattern-dots conveniently.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A measuring method for dots of a pattern distributed on a light guide plate uniform, comprising the steps of:
defining a coordinate system according to the dots selecting a unit area in the coordinate system;
accounting area of the dots in the unit area;
calculating area density of the dots;
wherein, quantity of the dots in each unit area is invariable, and area of each dot in the unit area is equal.

2. The method as described in claim 1, wherein the dots are distributed in rows and columns.

3. The method as described in claim 2, wherein the dots are arranged at same intervals in rows and columns, respectively.

4. The method as described in claim 1, wherein the dots are shaped as circle.

5. The method as described in claim 4, wherein the dots are distributed in rows and columns at respectively same intervals.

6. The method as described in claim 5, wherein the steps of calculating area density of the dots can use a equation expressed as: σ=π[r²_{(n, m)}+r²_{(n+1, m)}+r²_{(n,m+1)}+r²_{(n+1,m+1)}]/cd, (n,m) is a coordinate of the dot, r_{(n,m)} is a semi diameter of the dot, c is column spacing of the dots, and d is row pitch of the dots.

7. The method as described in claim 1, wherein the dots are shaped as foursquare.

8. The method as recited in claim 7, wherein the dots are distributed in rows and columns at respectively same intervals.

9. The method as described in claim 8, wherein the steps of calculating area density of the dots can use a following equation: σ=0.25[1²_{(n,m)}+1²_{(n+1, m)} +1²_{(n,m+1)}+1²_{(n+1,m+1)}]/ab, (n,m) is a coordinate of the dot, 1_{(n,m)} is a length of edge of the dot, a is column spacing of the dots, and b is the row pitch of the dots.

10. The method as described in claim 1, wherein the dots are shaped elliptic.

11. The method as described in claim 1, wherein the dots are shaped as rectangular.

12. A measuring arrangement for dots of a pattern distributed on the light guide plate, comprising:
defining a coordinate system covering the dots;
determining a plurality of unit areas in the coordinate system;
accounting area of the dots in each of the unit areas;
calculating area density of the dots; wherein quantity of the dots in each of the unit area is same, and the dot, which occupies more than one unit areas, occupies the same sized area in the corresponding more than one unit areas, respectively.
